(19) United States
(12) Patent Application Publication
(10) Pub. No.: US 2020/0025257 A1
(43) Pub. Date: Jan. 23, 2020

(54) POWERTRAIN OF HYBRID ELECTRIC VEHICLE

(71) Applicants: HYUNDAI MOTOR COMPANY, Seoul (KR); KIA MOTORS CORPORATION, Seoul (KR)

(72) Inventors: Hong Seok YANG, Suwon-Si (KR); Jae Young CHOI, Busan (KR); Hee Ra LEE, Anyang-Si (KR)

(21) Appl. No.: 16/183,310

(22) Filed: Nov. 7, 2018

(30) Foreign Application Priority Data
Jul. 17, 2018 (KR) 10-2018-0083034

(51) Int. Cl. F16D 1/116; H02K 7/00; H02K 7/108; H02K 5/24

(52) U.S. Cl. CPC F16D 1/116; H02K 7/006; B60K 6/387; H02K 5/24; H02K 7/108

(57) ABSTRACT

A powertrain of a hybrid electric vehicle includes: a sleeve drum comprising a main body having an open-topped-drum shape, a plurality of protrusions protruding toward a center of the sleeve drum and arranged on an inner sidewall of the main body to be equidistantly spaced apart from each other, and a plurality of insertion grooves concaved outwardly between the plurality of protrusions; and a retainer cover seated inside the sleeve drum and comprising a plurality of radial protrusions having a shape corresponding to that of each of the plurality of protrusions and the plurality of insertion grooves.

### CROSS-REFERENCE TO RELATED APPLICATION

This application claims the benefit of Korean Patent Application No. 10-2018-0083034, filed on Jul. 17, 2018, which is hereby incorporated by reference as if fully set forth herein.

### TECHNICAL FIELD

The present disclosure relates to a vehicle, and more particularly, to the structure of a powertrain of a hybrid electric vehicle.

### BACKGROUND

In general, a hybrid electric vehicle (HEV) is a vehicle that uses two or more types of drive sources in a combined manner, by using an electric motor and an internal combustion engine or by using an internal combustion engine and a fuel cell. Such a hybrid electric vehicle is environmentally friendly and has excellent fuel efficiency and power performance, compared to an existing vehicle that is driven using only an internal combustion engine.

For example, a hybrid electric vehicle may include a powertrain of a transmission mounted electric device (TMED) type in which an electric motor is mounted in an automatic transmission.

Operation modes of the hybrid electric vehicle, to which the TMED type is applied, are broadly classified into an HEV mode in which an engine and an electric motor are driven together and an electric vehicle (EV) mode in which only an electric motor is driven. Here, the selection of the EV mode and the HEV mode is performed by controlling the operation of an engine clutch of the powertrain.

FIG. 1 is a view illustrating the structure of a powertrain of a general TMED-type hybrid electric vehicle.

Referring to FIG. 1, the power train of the TMED-type hybrid electric vehicle includes an automatic transmission 1, an electric motor 2, and an engine clutch 3.

The electric motor 1 includes a stator 2a and a rotor 2b, and is mounted in a manner such that the engine clutch 3 is connected to the inner side of the rotor 2b. Specifically, a rotation axis 2c of the rotor 2b is connected to a retainer 4 of the engine clutch 3 so that power may be transmitted to an input shaft 6 of the automatic transmission 1.

The engine clutch 3 includes a multi-plate clutch 5. As described above, the engine clutch 3 may interconnect the automatic transmission 1 and the electric motor 2, or may interconnect the automatic transmission 1 and a drive shaft of an engine (not illustrated). To this end, the engine clutch 3 may provide power of the engine, which is input through a torsional damper 8 mounted on a front shaft 7, which is connected in series to the input shaft 6 of the automatic transmission 1, to the input shaft 6 of the automatic transmission 1.

The powertrain of the TMED-type hybrid electric vehicle operates while switching between an EV mode and an HEV mode. However, when switching from the EV mode to the HEV mode, the engine torque suddenly changes, which causes shaking of the engine clutch and generates rattling noise.

### SUMMARY

The present disclosure is directed to a powertrain of a hybrid electric vehicle that substantially obviates one or more problems due to limitations and disadvantages of the related art.

An object of the present disclosure is to provide a powertrain of a hybrid electric vehicle capable of preventing rattling noise generated upon switching from an EV mode to a hybrid electric vehicle (HEV) mode of a transmission mounted electric device (TMED)-type hybrid electric vehicle and a hybrid electric vehicle having the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

According to an exemplary embodiment of the present disclosure, a powertrain of a hybrid electric vehicle includes: a sleeve drum comprising a main body having an open-topped-drum shape, a plurality of protrusions protruding toward a center of the sleeve drum and arranged on an inner sidewall of the main body to be equidistantly spaced apart from each other, and a plurality of insertion grooves concaved outwardly between the plurality of protrusions; and a retainer cover seated inside the sleeve drum and comprising a plurality of radial protrusions having a shape corresponding to that of each of the plurality of protrusions and the plurality of insertion grooves.

The main body may further include an exposed surface having a consistent height in a horizontal plane.

The powertrain may further include at least one snap-ring groove formed in each of the protrusions.

The snap-ring groove may include a first snap-ring groove and a second snap-ring groove formed in the protrusion.

The first snap-ring groove may be located in an upper inner region of the protrusion, and the second snap-ring groove may be located in a lower inner region of the protrusion.

The retainer cover may include the radial protrusions corresponding to the protrusions and the insertion grooves.

The radial protrusions may be inserted into the insertion grooves between the protrusions of the sleeve drum so as not to be exposed from the exposed surface of the sleeve drum.

The main body may be manufactured through a flow-forming forging method.

According to another exemplary embodiment of the present disclosure, a powertrain of a hybrid electric vehicle includes: a main body having an open-topped-drum shape; a plurality of protrusions protruding toward a center of the sleeve drum and arranged on an inner sidewall of the main body to be equidistantly spaced apart from each other; a plurality of insertion grooves concaved on the inner sidewall of the main body to have spaces between the plurality of protrusions; an exposed surface of the main body having a consistent height in a horizontal plane; and at least one snap-ring groove in each of the plurality of protrusions.

The powertrain may further include a retainer cover seated in the main body and comprising a plurality of radial protrusions having a shape corresponding to that of the protrusions and the insertion grooves.

The radial protrusions may be provided in a number corresponding to that of the protrusions and the insertion grooves.

The radial protrusions may be inserted into the insertion grooves between the protrusions so as not to be exposed from the exposed surface.

The main body may be manufactured through a flow-forming forging method.

It is to be understood that both the foregoing general description and the following detailed description of the present disclosure are exemplary and explanatory and are intended to provide further explanation of the present disclosure as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating the structure of a powertrain of a general transmission mounted electric device (TMED)-type hybrid electric vehicle;

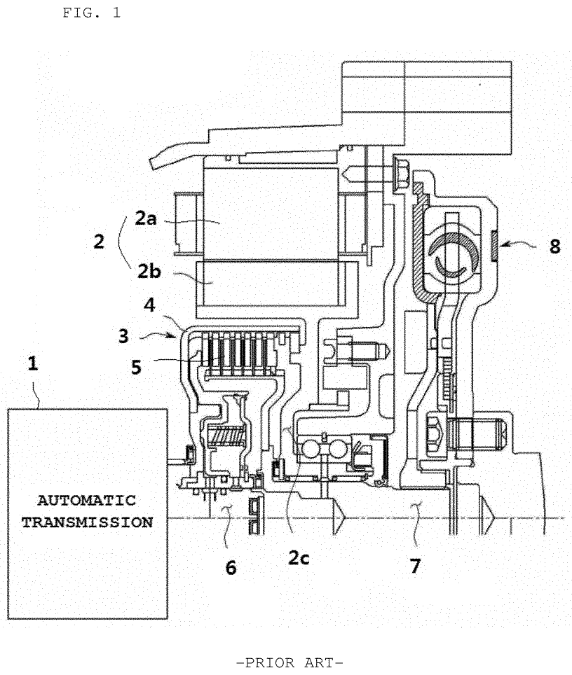

FIG. 2 is a partially cut-away perspective view illustrating major elements of a powertrain of a TMED-type hybrid electric vehicle according to an embodiment of the present disclosure;

FIG. 3 is a partially enlarged view illustrating the coupling structure of a rotor sleeve, a retainer drum, and a retainer cover illustrated in FIG. 2;

FIG. 4 is an exploded cut-away perspective view of the rotor sleeve and the retainer drum illustrated in FIG. 2;

FIG. 5 is a perspective view illustrating a sleeve drum according to an embodiment of the present disclosure;

FIG. 6 is a partially enlarged view of FIG. 5; and

FIG. 7 is a partially enlarged view illustrating the coupling structure of the sleeve drum and the retainer cover illustrated in FIG. 2.

### DETAILED DESCRIPTION

Hereinafter, embodiments will be apparent become apparent with reference to embodiments described below in detail in conjunction with the accompanying drawings. In the description of the embodiments, it will be understood that, when an element such as a layer (film), region, pattern or structure is referred to as being formed “on” or “under” another element, such as a substrate, layer (film), region, pad or pattern, it can be directly “on” or “under” the other element or be indirectly formed with intervening elements therebetween. It will also be understood that “on” or “under” the element may be described relative to the drawings.

In the drawings, the thickness or size of each layer may be exaggerated, omitted or schematically illustrated for clarity and convenience. In addition, the size of each constituent element does not wholly reflect an actual size thereof. In addition, the same reference numerals in different figures denote the same elements. Hereinafter, the embodiments will be described with reference to the accompanying drawings.

The embodiments illustrate a powertrain of a TMED-type hybrid electric vehicle, but are not limited thereto, and the present disclosure may be applied to various types of hybrid electric vehicles.

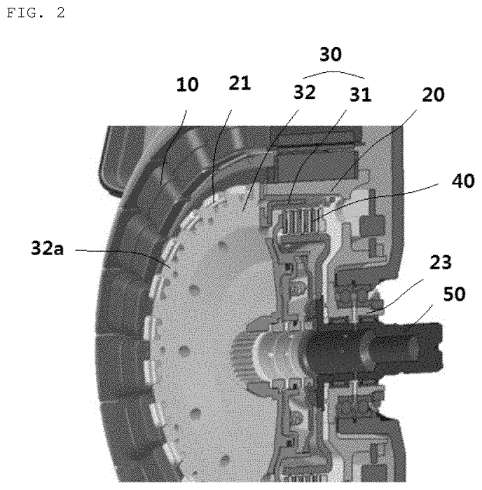

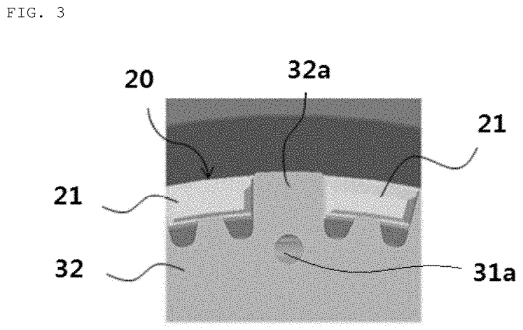

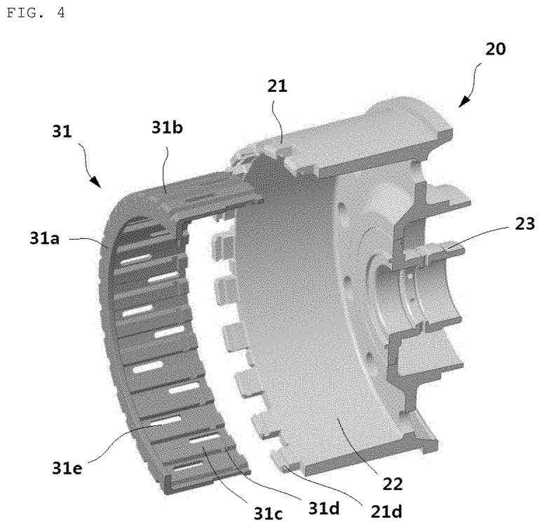

FIG. 2 is a partially cut-away perspective view illustrating major elements of a powertrain of a TMED-type hybrid electric vehicle according to an embodiment of the present disclosure, FIG. 3 is a partially enlarged view illustrating the coupling structure of a rotor sleeve, a retainer drum, and a retainer cover illustrated in FIG. 2, and FIG. 4 is an exploded cut-away perspective view of the rotor sleeve and the retainer drum illustrated in FIG. 2.

As illustrated in FIG. 2, in the powertrain of the TMED-type hybrid electric vehicle according to the embodiment, a rotor sleeve 20 is rotatably inserted into a stator coil 10 and a retainer 30 is provided inside the rotor sleeve 20. The retainer 30 is formed by coupling a retainer drum 31 and a retainer cover 32 with each other. A multi-plate clutch 40 is mounted inside the retainer 30.

The rotor sleeve 20, as illustrated in FIG. 4, may take the form of an open-topped drum. Multiple crown portions 21 are spaced apart from each other on the upper portion side of the rotor sleeve 20 to define spaces into which respective radial protrusions 32a of the retainer cover 32, which will be described below, are inserted. A rotor rotating shaft 23 may be provided on the lower portion side of the rotor sleeve 20.

First snap-ring grooves 21d may be formed in the inner surfaces of the crown portions 21. A snap ring (not illustrated) may be fitted into the first snap-ring groove 21d.

The rotor sleeve 20 having the above-described configuration may operate so as to rotate inside the stator coil 10.

The retainer 30 may be provided inside the rotor sleeve 20 so as to be spline-coupled with the rotor sleeve 20. To this end, the retainer 30 may include the retainer drum 31 and the retainer cover 32.

The retainer drum 31 may include an outer-wall portion 31b, which has a ring shape and protrudes at a constant interval so as to come into close contact with the rotor sleeve 20, and a seating portion 31a, which is bent inwards from the outer-wall portion 31b so as to allow the retainer cover 32 to be seated thereon.

Multiple protrusions 31c may be equidistantly spaced apart from each other on the inner periphery of the retainer drum 31, and second snap-ring grooves 31d may be formed in the protrusions 31c. A snap ring (not illustrated) may be assembled into the second snap-ring grooves 31d and may serve to axially fix the engine clutch.

Multiple elongated holes 31e may be formed between the outer-wall portion 31b and the protrusions 31c of the retainer drum 31. The elongated holes 31e may serve as holes for the discharge of an engine clutch cooling oil.

The retainer drum 31 described above may be integrally coupled inside the rotor sleeve 20, and the retainer cover 32 may be mounted through the rotor sleeve 20 and the retainer drum 31.

The retainer cover 32, as illustrated in FIG. 2, may generally have a disc shape, and may be stepped downwards from the outer side to the center in the radial direction. That is, the retainer cover 32 may include a stepped portion that is recessed further inwards from the outer side to the center in the radial direction. For example, the stepped portion may include three stages.

The radial protrusions 32a may be formed on the outer periphery of the retainer cover 32. As illustrated in FIG. 3, the outer lower surface of the retainer cover 32 may be seated on the seating portion 31a of the retainer drum 31, and the radial protrusions 32a may be fitted between the crown portions 21 of the rotor sleeve 20.

As such, the retainer cover 32 may be spline-coupled with the rotor sleeve 20 and the retainer drum 31. Reference numeral 40 denotes a multi-plate clutch, and reference numeral 50 denotes a hub.

Upon switching from an EV mode to an HEV mode, as the engine clutch of the powertrain moves in the clockwise or counterclockwise direction, the retainer 30 may collide with the rotor sleeve 20 due to fine gaps between the radial protrusions 32a of the retainer cover 32 and the crown portions 21 of the rotor sleeve 20, which may cause rattling noise.

Therefore, the present disclosure may further include a sleeve drum in which the rotor sleeve 20 and the retainer drum 31 are integrated so as to prevent rattling noise.

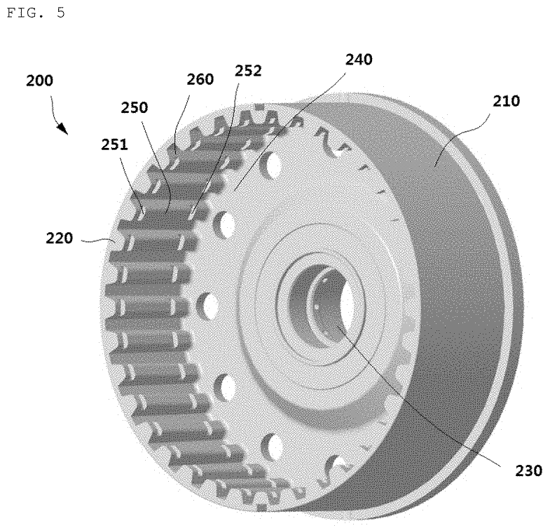

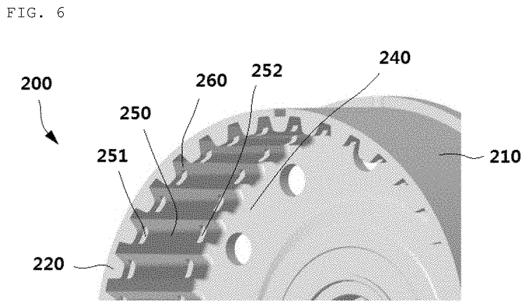

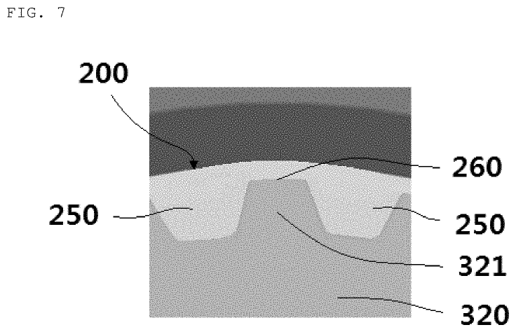

FIG. 5 is a perspective view illustrating a sleeve drum according to an embodiment of the present disclosure, FIG. 6 is a partially enlarged view of FIG. 5, and FIG. 7 is a partially enlarged view illustrating the coupling structure of the sleeve drum and the retainer cover illustrated in FIG. 2.

As illustrated in FIG. 5, the sleeve drum 200 of the present embodiment may be broadly composed of a main body 210 and a rotor rotating shaft 230 coupled to the main body 210.

The main body 210 may perform all of the functions of the rotor sleeve 20 and the retainer drum 31 of the above-described embodiment.

For example, the main body 210 may be manufactured through a flow-forming forging method. When the main body 210 is manufactured by flow forming, metal tissues are reinforced to maximize the strength, whereby the sleeve drum 200 may have an integrated structure, unlike the above-described embodiment in which the rotor sleeve 20 and the retainer drum 31 are provided separately from each other. As such, the number of elements and manufacturing costs may be reduced.

The main body 210 may take the form of an open-topped drum. An upper portion of the main body 210 has an upper surface, which forms an exposed surface 220 having a consistent height in the horizontal plane, unlike the above-described embodiment in which the crown portions 21 protrude from the upper portion.

The outer surface of the main body 210 may be rotatably inserted into the stator coil 10 described above.

The inner bottom surface of the main body 210 forms a seating surface 240, on which multiple elements, such as the multi-clutch 40 (see FIG. 2), is seated, and the rotor rotating shaft 230 may be coupled to a central area of the seating surface 240.

The main body 210 may be formed on an inner sidewall thereof with protrusions 250 and insertion grooves 260.

The protrusions 250 and the insertion grooves 260 are formed so as to correspond to the shape of a retainer cover 320, and the retainer cover 320 may be spline-coupled with the sleeve drum 200.

For example, the multiple protrusions 250 may be equidistantly spaced apart from each other along the inner sidewall of the main body 210 with the insertion grooves 260 interposed therebetween. As illustrated in FIG. 7, the protrusions 250 may be closely fitted into the spaces between radial protrusions 321 of the retainer cover 320.

Each of the protrusions 250 may be formed with a first snap-ring groove 251 and a second snap-ring groove 252. The first snap-ring groove 251 may be located close to the open top region of the sleeve drum 200, and the second snap-ring groove 252 may be located close to the seating surface 240 of the sleeve drum 200. As such, in the present embodiment, the protrusion 250 may be formed with both the first snap-ring groove 251 and the second snap-ring groove 252, unlike the above-described embodiment.

As illustrated in FIG. 7, when the above-described protrusions 250 are closely fitted into the spaces between the radial protrusions 321 of the retainer cover 320, the radial protrusions 321 of the retainer cover 320 may be closely inserted into the insertion grooves 260.

The retainer cover 320 may include the radial protrusions 321 having a shape corresponding to that of the insertion grooves 260 and the protrusions 250 of the sleeve drum 200 described above. The retainer cover 320 may be fitted so as not to be exposed to the outside, i.e. from the exposed surface 220 of the sleeve drum 200 when the radial protrusions 321 are inserted into the insertion grooves 260 located between the protrusions 250 of the sleeve drum 200.

In this way, since the protrusions 250 and the insertion grooves 260 have a shape corresponding to that of the radial protrusions 321 of the retainer cover 320, the retainer cover 320 may be further firmly spline-coupled with the sleeve drum 200 without forming gaps therebetween.

Accordingly, upon switching from an EV mode to an HEV mode, even if the engine clutch of the powertrain moves in the clockwise or counterclockwise direction, the radial protrusions 321 of the retainer cover 320 come into close contact with the sleeve drum 200, which may prevent generation of rattling noise.

As is apparent from the above description, according to a powertrain of a hybrid electric vehicle and a hybrid electric vehicle having the same of the present disclosure, even if an engine clutch of the powertrain moves in the clockwise or counterclockwise direction upon switching from an EV mode to an HEV mode, a retainer cover and a sleeve drum are brought into close contact with each other so as to attenuate vibration by inertia, which may prevent rattling noise.

In addition, according to the present disclosure, the retainer drum and a rotor sleeve may constitute one element, which may reduce the number of elements and reduce manufacturing costs.

The above described features, configurations, effects, and the like are included in at least one of the embodiments of the present disclosure, and should not be limited to only one embodiment. In addition, the features, configurations, effects, and the like as illustrated in each embodiment may be implemented with regard to other embodiments as they are combined with one another or modified by those skilled in the art. Thus, content related to these combinations and modifications should be construed as including in the scope and spirit of the invention as disclosed in the accompanying claims.

What is claimed is:

1. A powertrain of a hybrid electric vehicle, comprising:
a sleeve drum comprising:
a main body having an open-topped-drum shape;
a plurality of protrusions protruding toward a center of the sleeve drum and arranged on an inner sidewall of the main body to be equidistantly spaced apart from each other; and
a plurality of insertion grooves concaved outwardly between spaces between the plurality of protrusions; and
a retainer cover seated inside the sleeve drum and comprising a plurality of radial protrusions having a shape corresponding to that of each of the plurality protrusions and the plurality of insertion grooves.

2. The powertrain according to claim 1, wherein the main body further comprises an exposed surface having a consistent height in a horizontal plane.

3. The powertrain according to claim 1, further comprising at least one snap-ring groove in each of the plurality of protrusions.

4. The powertrain according to claim 3, wherein the at least one snap-ring groove comprises a first snap-ring groove and a second snap-ring groove.

5. The powertrain according to claim 4, wherein the first snap-ring groove is located at an upper inner region of each of the plurality of protrusions, and the second snap-ring groove is located at a lower inner region of each of the plurality of protrusions.

6. The powertrain according to claim 2, wherein the plurality of radial protrusions are fitted inside and correspond to the plurality of protrusions and the plurality of insertion grooves.

7. The powertrain according to claim 6, wherein the plurality of radial protrusions are inserted into the plurality of insertion grooves between the plurality of protrusions of the sleeve drum to prevent from exposing from the exposed surface of the sleeve drum.

8. A powertrain of a hybrid electric vehicle, comprising:
a main body having an open-topped-drum shape;
a plurality of protrusions protruding toward a center of the sleeve drum and arranged on an inner sidewall of the main body to be equidistantly spaced apart from each other;
a plurality of insertion grooves concaved on the inner sidewall of the main body to have spaces between the plurality of protrusions;
an exposed surface of the main body having a consistent height in a horizontal plane; and
at least one snap-ring groove in each of the plurality of protrusions.

9. The powertrain according to claim 8, further comprising a retainer cover seated in the main body,
wherein the retainer cover comprises a plurality of radial protrusions having a shape corresponding to those of the plurality of protrusions and the plurality of insertion grooves.

10. The powertrain according to claim 9, wherein a number of the radial protrusions correspond to that of each of the plurality of protrusions and the plurality of insertion grooves.

11. The powertrain according to claim 10, wherein the plurality of radial protrusions are inserted into the plurality of insertion grooves between the plurality of protrusions to prevent from exposing from the exposed surface.
